(19) United States
(12) Patent Application Publication
(10) Pub. No.: US 2023/0303044 A1
(43) Pub. Date: Sep. 28, 2023

(54) VEHICLE BRAKING DEVICE AND FAILURE DETERMINATION METHOD THEREFOR

(71) Applicant: TOYOTA JIDOSHA KABUSHIKI KAISHA, Toyota-shi (JP)

(72) Inventor: Yusuke KAMIYA, Toyota-shi (JP)

(73) Assignee: TOYOTA JIDOSHA KABUSHIKI KAISHA, Toyota-shi (JP)

(21) Appl. No.: 18/107,315

(22) Filed: Feb. 8, 2023

(30) Foreign Application Priority Data
Mar. 22, 2022 (JP) 2022-045818

(51) Int. Cl. B60T 8/88; B60T 17/22

(52) U.S. Cl. CPC B60T 8/885; B60T 17/22; B60T 2270/88; B60T 2270/406

(57) ABSTRACT

A vehicle braking device includes a braking actuator, a hydraulic pressure generation device, a hydraulic pressure sensor, and an electronic control unit. The electronic control unit is configured to execute an upstream pressure maintaining process of controlling the hydraulic pressure generation device to increase and maintain the upstream hydraulic pressure, a downstream pressurization process of controlling the braking actuator such that hydraulic fluid is supplied to the wheel cylinder through the hydraulic pressure flow path in a state in which the upstream hydraulic pressure is maintained, and a failure determination process of determining that a failure has occurred in the braking actuator in a case where the upstream hydraulic pressure is not decreased to be equal to or lower than a determination threshold value as the downstream pressurization process is executed.

### CROSS-REFERENCE TO RELATED APPLICATION

This application claims priority to Japanese Patent Application No. 2022-045818 filed on Mar. 22, 2022, incorporated herein by reference in its entirety.

### BACKGROUND

### 1. Technical Field

The present disclosure relates to a vehicle braking device and a failure determination method therefor.

### 2. Description of Related Art

Japanese Unexamined Patent Application Publication No. 2010-042744 (JP 2010-042744 A) discloses a vehicle braking device. The vehicle braking device includes a hydraulic actuator. The hydraulic actuator appropriately adjusts a hydraulic pressure of brake fluid supplied from a power hydraulic pressure source or a master cylinder unit and sends the adjusted hydraulic pressure to a wheel cylinder. In the vehicle braking device, a plurality of hydraulic pressure sensors provided in hydraulic pressure pipes for supplying the hydraulic pressure to the wheel cylinder are used to detect an abnormality in the hydraulic actuator. Specifically, the abnormality detection is executed based on a relative relationship between output values of the hydraulic pressure sensors.

### SUMMARY

As described above, in the abnormality detection of the hydraulic actuator (braking actuator) in the vehicle braking device disclosed in JP 2010-042744 A, the relative relationship between the output values of the hydraulic pressure sensors provided in the hydraulic pressure pipes for supplying the hydraulic pressure to the wheel cylinder is needed. Such a configuration leads to an increase in a cost of the vehicle braking device.

The present disclosure has been made in view of the problems described above, and is to enable to make a failure determination for a braking actuator that controls a hydraulic pressure in a wheel cylinder by using an upstream hydraulic pressure supplied to the braking actuator.

A first aspect of the present disclosure relates to a vehicle braking device includes a braking actuator, a hydraulic pressure generation device, a hydraulic pressure sensor, and an electronic control unit. The braking actuator is configured to control a hydraulic pressure in a wheel cylinder. The hydraulic pressure generation device is connected to the braking actuator through a hydraulic pressure flow path and is configured to execute increasing and maintaining an upstream hydraulic pressure supplied to the braking actuator through the hydraulic pressure flow path. The hydraulic pressure sensor is configured to detect the upstream hydraulic pressure. The electronic control unit is configured to execute an upstream pressure maintaining process of controlling the hydraulic pressure generation device to increase and maintain the upstream hydraulic pressure. The electronic control unit is configured to execute a downstream pressurization process of controlling the braking actuator such that hydraulic fluid is supplied to the wheel cylinder through the hydraulic pressure flow path in a state in which the upstream hydraulic pressure is maintained. The electronic control unit is configured to execute a failure determination process of determining that a failure has occurred in the braking actuator in a case where the upstream hydraulic pressure is not decreased to be equal to or lower than a determination threshold value as the downstream pressurization process is executed.

A second aspect of the present disclosure relates to a failure determination method for a vehicle braking device is a method of determining the presence or absence of a failure of a vehicle braking device including a braking actuator configured to control a hydraulic pressure in a wheel cylinder, a hydraulic pressure generation device connected to the braking actuator through a hydraulic pressure flow path and configured to execute increasing and maintaining an upstream hydraulic pressure supplied to the braking actuator through the hydraulic pressure flow path, and a hydraulic pressure sensor configured to detect the upstream hydraulic pressure. The failure determination method includes an upstream pressure maintaining process of controlling the hydraulic pressure generation device to increase and maintain the upstream hydraulic pressure. The failure determination method includes a downstream pressurization process of controlling the braking actuator such that hydraulic fluid is supplied to the wheel cylinder through the hydraulic pressure flow path in a state in which the upstream hydraulic pressure is maintained. The failure determination method includes a failure determination process of determining that a failure has occurred in the braking actuator in a case where the upstream hydraulic pressure is not decreased to be equal to or lower than a determination threshold value as the downstream pressurization process is executed.

According to the present disclosure, the failure determination for the braking actuator can be made by using the hydraulic pressure sensor that detects the upstream hydraulic pressure supplied to the braking actuator. That is, the failure determination for the braking actuator can be made without including the hydraulic pressure sensors that directly detect individual wheel cylinder pressures.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a configuration of a vehicle braking device according to an embodiment;

FIG. 2 is a flowchart showing a flow of a process related to a failure determination for a braking actuator according to the embodiment; and

FIG. 3 is a time chart showing behavior of a master cylinder pressure Pmc (upstream hydraulic pressure) and a wheel cylinder pressure Pwc during execution of the failure determination for the braking actuator according to the embodiment.

### DETAILED DESCRIPTION OF EMBODIMENTS

In the following, an embodiment of the present disclosure will be described with reference to the accompanying drawings. Note that, in a case where the number, a quantity, an amount, a range, and the like of each element are described in the following embodiment, the technical idea according to the present disclosure is not limited to the described numerical values except for a case of being particularly pointed out or a case of being clearly specified in principle by the described numerical values.

### 1. Configuration of Vehicle Braking Device

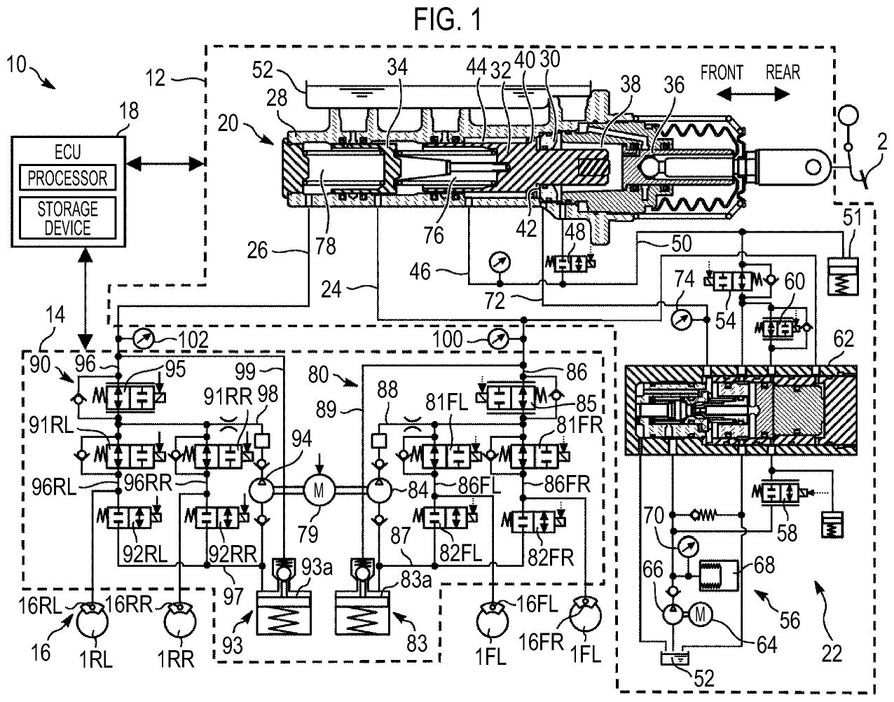

FIG. 1 is a diagram showing a configuration of a vehicle braking device 10 according to an embodiment. The vehicle braking device 10 shown in FIG. 1 is mounted on a vehicle and brakes the vehicle. The vehicle braking device 10 includes a hydraulic pressure generation device 12, a braking actuator 14, a braking mechanism 16, and an electronic control unit (ECU) 18.

The braking mechanism 16 is, for example, a disc type, and is provided individually for each of wheels 1FL, 1FR, 1RL, 1RR of the vehicle. The braking mechanism 16 includes wheel cylinders 16FL, 16FR, 16RL, 16RR corresponding to the wheels 1FL, 1FR, 1RL, 1RR, respectively.

The hydraulic pressure generation device 12 includes a master cylinder 20 and is configured to generate a hydraulic pressure in response to an operation of a brake pedal 2 as a braking operation member. In addition, the hydraulic pressure generation device 12 also includes a servo pressure generation device 22 that can generate the hydraulic pressure without depending on the operation of the brake pedal 2. The braking actuator 14 receives the supply of the hydraulic pressure from the hydraulic pressure generation device 12.

The hydraulic pressure generation device 12 and the braking actuator 14 are controlled by the ECU 18. By actuating the hydraulic pressure generation device 12 by the ECU 18, the hydraulic pressures (wheel cylinder pressures Pwc) of hydraulic fluid in all the wheel cylinders 16FL, 16FR, 16RL, 16RR can be collectively controlled. In addition, the braking actuator 14 is configured to individually control the wheel cylinder pressures Pwc of the wheel cylinders 16FL, 16FR, 16RL, 16RR by controlling the hydraulic pressure supplied from the hydraulic pressure generation device 12.

The ECU 18 controls actuations of the hydraulic pressure generation device 12 and the braking actuator 14. Specifically, the ECU 18 includes a processor, a storage device, and an input/output interface. The input/output interface takes in sensor signals from sensors (hydraulic pressure sensors 70, 74, upstream hydraulic pressure sensors 100, 102, and the like described below) attached to the vehicle, and outputs operation signals to the hydraulic pressure generation device 12 and the braking actuator 14. The processor executes various processes related to control of the hydraulic pressure generation device 12 and the braking actuator 14. The storage device stores various programs and various data (including maps) used for the process by the processor. The process by the ECU 18 is realized by the processor reading out the program from the storage device and executing the read out program.

Note that a plurality of ECUs 18 may be provided. For example, the ECU 18 may include an ECU that controls the actuation of the hydraulic pressure generation device 12 and an ECU that controls the actuation of the braking actuator 14. More specifically, the hydraulic pressure generation device 12 and the braking actuator 14 may be configured as separate units. For example, the hydraulic pressure generation device 12 is configured as one unit with the ECU that controls the actuation of the hydraulic pressure generation device 12, and the braking actuator 14 may be configured as another unit with the ECU that controls the actuation of the braking actuator 14.

1-1. Hydraulic Pressure Generation Device

As described above, the hydraulic pressure generation device 12 includes the master cylinder 20 and the servo pressure generation device 22. The master cylinder is connected to the braking actuator 14 through hydraulic pressure flow paths 24, 26. Note that, in the description of the master cylinder 20, as shown in FIG. 1, a left side of a paper surface is referred to as a front side, and a right side of the paper surface is referred to as a rear side.

The master cylinder 20 has a cylinder body 28. An inside of the cylinder body 28 is partitioned into a front chamber and a rear chamber by a partition wall 30 having an annular shape. A first master piston 32 and a second master piston 34 are disposed in the front chamber. An input piston 36 having a rear end portion coupled to the brake pedal 2 is disposed in the rear chamber. The first master piston 32 and the second master piston 34 each move forward to pressurize the hydraulic fluid and supply the pressurized hydraulic fluid to the braking actuator 14 through hydraulic pressure flow paths 24, 26. The input piston 36 moves forward by a brake operation force applied to the brake pedal 2.

The first master piston 32 penetrates the partition wall 30 and protrudes into the rear chamber. An inter-piston chamber 38 is formed between the first master piston 32 and the input piston 36. In addition, the first master piston 32 also has a flange portion 40 formed to face the partition wall 30 on a side of the front chamber. A servo chamber 42 having an annular shape is formed between the flange portion 40 and the partition wall 30. The hydraulic fluid of which the pressure is adjusted by the servo pressure generation device 22 is introduced into the servo chamber 42.

On the other hand, on a front side of the flange portion 40, a facing chamber 44 having an annular shape and facing the servo chamber 42 with the flange portion 40 therebetween is formed. The inter-piston chamber 38 and the facing chamber 44 are connected by the hydraulic pressure flow path 46. An electromagnetic valve 48 is disposed in the hydraulic pressure flow path 46. In addition, the hydraulic pressure flow path 46 is connected to a first end of the hydraulic pressure flow path 50 between the facing chamber 44 and the electromagnetic valve 48. A second end side of the hydraulic pressure flow path 50 is branched into two branches, one of which is connected to a regulator 62 and the other of which is connected to a reaction force generation device 51 including a stroke simulator. The electromagnetic valve 54 is disposed in the hydraulic pressure flow path 50 after being branched to a side of the regulator 62.

The servo pressure generation device 22 includes a power hydraulic pressure source 56, a pressure increase valve 58, a pressure decrease valve 60, and the regulator 62 of a mechanical type. The power hydraulic pressure source 56 generates a high hydraulic pressure independently of a brake operation of a driver by supplying power. The pressure increase valve 58 is a normally closed type linear electromagnetic valve. The pressure decrease valve 60 is a normally open type linear electromagnetic valve.

The power hydraulic pressure source 56 includes an electric motor 64, a pump 66 for servo, an accumulator 68, and the hydraulic pressure sensor 70 that detects the hydraulic pressure in the accumulator 68 (accumulator pressure Pa). The pump 66 is driven by the electric motor 64 to pump up the hydraulic fluid from an atmospheric pressure reservoir 52 and pressurize the hydraulic fluid. The accumulator 68 stores the hydraulic fluid pressurized by the pump 66. The ECU 18 controls the actuation of the pump 66 by controlling the electric motor 64 such that the accumulator pressure detected by the hydraulic pressure sensor 70 falls within a set range. The high-pressure hydraulic fluid in the accumulator 68 is supplied to the regulator 62. The regulator 62 adjusts the pressure of the supplied hydraulic fluid and supplies the adjusted hydraulic fluid to the master cylinder 20.

An operation mode of the vehicle braking device 10 controlled by the ECU 18 include a linear mode. In the linear mode, the inter-piston chamber 38 and the facing chamber 44 are communicated with each other by opening the electromagnetic valve 48. In addition, by closing the electromagnetic valve 54, the communication between the facing chamber 44 and the atmospheric pressure reservoir 52 through the regulator 62 is cut off. By controlling opening degrees of the pressure increase valve 58 and the pressure decrease valve 60 in the control state, a servo pressure Psv that is the hydraulic pressure in the servo chamber 42 in the master cylinder 20 is controlled. The servo pressure Psv is detected by the hydraulic pressure sensor 74 disposed in the hydraulic pressure flow path 72 connecting the regulator 62 and the servo chamber 42 to each other.

The rear chamber inside the cylinder body 28 includes a first master chamber 76 and a second master chamber 78. The first master chamber 76 is formed by being partitioned by the cylinder body 28, the first master piston 32, and the second master piston 34. The second master chamber 78 is adjacent to the first master chamber 76 through the second master piston 34 and is formed by being partitioned by the cylinder body 28 and the second master piston 34.

In a case where the servo pressure Psv is increased by controlling the pressure increase valve 58 and the pressure decrease valve 60, both the first master piston 32 and the second master piston 34 move toward the front side. As a result, the communication between the atmospheric pressure reservoir 52 and each of the master chambers 76, 78 is released, and the hydraulic pressure (master cylinder pressure Pmc) in each of the master chambers 76, 78 is increased. On the other hand, in a case where the servo pressure Psv is decreased by controlling the pressure increase valve 58 and the pressure decrease valve 60, both the first master piston 32 and the second master piston 34 move toward the rear side. As a result, the master cylinder pressure Pmc in each of the master chambers 76, 78 is decreased.

As described above, with the servo pressure generation device 22, the master cylinder pressure Pmc in each of the master chambers 76, 78 can be controlled by controlling the pressure increase valve 58 and the pressure decrease valve 60 to control the servo pressure Psv. Moreover, the master cylinder pressures Pmc in the master chambers 76, 78 are supplied to the braking actuator 14 through the hydraulic pressure flow paths 24, 26, respectively. Therefore, the master cylinder pressure Pmc corresponds to an example of an “upstream hydraulic pressure” according to the present disclosure.

More specifically, the master cylinder 20 is configured such that the master cylinder pressures Pmc in all the master chambers 76, 78 controlled as described above are substantially equal. Therefore, the master cylinder pressures Pmc (upstream hydraulic pressure) supplied to first and second control systems 80, 90 described below of the braking actuator 14 through the hydraulic pressure flow paths 24, 26, respectively, are also substantially equal.

Moreover, with the hydraulic pressure generation device 12, the master cylinder pressure Pmc (upstream hydraulic pressure) increased by increasing the servo pressure Psv as described above can be maintained. Specifically, the ECU 18 closes (more specifically, fully closes) the pressure decrease valve 60 of the servo pressure generation device 22 in a state in which the upstream hydraulic pressure is increased (that is, in a state in which the hydraulic fluid in the hydraulic pressure generation device 12 is pressurized). As a result, the hydraulic fluid can be contained in the inside of each of the master chambers 76, 78 and the inside of each of the hydraulic pressure flow paths 24, 26 and the braking actuator 14 positioned on a downstream side thereof. That is, the master cylinder pressure Pmc (upstream hydraulic pressure) is maintained.

1-2. Braking Actuator

The braking actuator 14 includes the first control system 80 and the second control system 90. The first control system 80 receives the supply of the master cylinder pressure Pmc from the first master chamber 76 through the hydraulic pressure flow path 24, and controls the wheel cylinder pressures Pwc of the wheel cylinders 16FR,16FL corresponding to the right and left front wheels 1FR, 1FL. On the other hand, the second control system 90 receives the supply of the master cylinder pressure Pmc from the second master chamber 78 through the hydraulic pressure flow path 26, and controls the wheel cylinder pressures Pwc of the wheel cylinders 16RR, 16RL corresponding to the right and left rear wheels 1RR, 1RL.

The first control system 80 includes pressure increase valves 81FL, 81FR, pressure decrease valves 82FL, 82FR, a reservoir 83, a pump 84, and an electromagnetic valve 85. The pressure increase valves 81FL, 81FR are normally open type electromagnetic valves. The pressure decrease valves 82FL, 82FR are normally closed type electromagnetic valves. The braking actuator 14 includes an electric motor 79 that drives the pump 84. In the configuration example shown in FIG. 1, the electric motor 79 is shared between the first control system 80 and the second control system 90, and also drives a pump 94 of the second control system 90. Instead of such an example, the electric motors that drive the pumps 84, 94 may be provided separately. The electromagnetic valve 85 is a normally open type.

The first control system 80 includes a hydraulic pressure flow path 86 having a first end connected to the hydraulic pressure flow path 24 from the master cylinder 20. The hydraulic pressure flow path 86 is branched as branch flow paths 86FL, 86FR on the way. The branch flow paths 86FL, 86FR are connected to the wheel cylinders 16FL, 16FR, respectively. Therefore, the master cylinder pressure Pmc from the master cylinder 20 is transmitted to each of the wheel cylinders 16FL, 16FR through the hydraulic pressure flow path 86. The pressure increase valves 81FL, 81FR are disposed in the branch flow paths 86FL, 86FR, respectively.

In addition, the first control system 80 also includes a hydraulic pressure flow path 87. The hydraulic pressure flow path 87 connects each of the branch flow path 86FL between the pressure increase valve 81FL and the wheel cylinder 16FL and the branch flow path 86FR between the pressure increase valve 81FR and the wheel cylinder 16FR to each of the reservoir 83 and an inlet of the pump 84. The pressure decrease valves 82FL, 82FR are disposed in the hydraulic pressure flow path 87 at locations at which the hydraulic pressures in the branch flow paths 86FL, 86FR can be decreased. An outlet of the pump 84 is connected to the hydraulic pressure flow path 86 through the hydraulic pressure flow path 88 on an upstream side of the pressure increase valves 81FL, 81FR (close side to the master cylinder 20).

The electromagnetic valve 85 is disposed in the hydraulic pressure flow path 86 on the upstream side of the pressure increase valves 81FL, 81FR. In an open state, the electromagnetic valve 85 allows a communication state between a side of the master cylinder 20 and a side of the wheel cylinder 16FL. In the communication state, the master cylinder pressure Pmc and the wheel cylinder pressure Pwc are substantially equal. In addition, in a closed state, the electromagnetic valve 85 cuts off the communication.

The reservoir 83 is connected to the hydraulic pressure flow path 86 on an upstream side of the electromagnetic valve 85 through the hydraulic pressure flow path 89. The reservoir 83 is configured as follows. That is, when the pump 84 is not actuated, the reservoir 83 cuts off the communication between the hydraulic pressure flow path 89 and the hydraulic pressure flow paths 87, 88. On the other hand, when the pump 84 is actuated, a piston 83a in the reservoir 83 is operated to ensure the communication. As a result, the hydraulic fluid is supplied from the hydraulic pressure flow path 24 to the hydraulic pressure flow path 88 through the hydraulic pressure flow path 89 and the hydraulic pressure flow path 87.

The second control system 90 includes pressure increase valves 91RL, 91RR, pressure decrease valves 92RL, 92RR, a reservoir 93, the pump 94, an electromagnetic valve 95, a hydraulic pressure flow path 96 (including branch flow paths 96RL, 96RR), hydraulic pressure flow paths 97, 98, 99. Since such a configuration of the second control system 90 is the same as the configuration of the first control system 80, the detailed description thereof will be omitted.

With the braking actuator 14 configured as described above, for execution of various braking controls, such as vehicle stability control (VSC) and anti-lock brake control (ABS control), the wheel cylinder pressures Pwc of all the wheel cylinders 16FL, 16FR, 16RL, 16RR can be controlled individually.

In addition, with the braking actuator 14, the electric motor 79 is driven to actuate the pumps 84, 94 in a state in which opening degrees of the electromagnetic valves 85, 95 are made smaller than in a fully open state, so that the hydraulic fluid inside the braking actuator 14 can be pressurized by the braking actuator 14 alone.

1-3. Upstream Hydraulic Pressure Sensor

The vehicle braking device 10 includes upstream hydraulic pressure sensors 100, 102.

The upstream hydraulic pressure sensor 100 detects the upstream hydraulic pressure (master cylinder pressure Pmc) supplied from the first master chamber 76 to the first control system 80 of the braking actuator 14. As an example, the upstream hydraulic pressure sensor 100 is attached to the hydraulic pressure flow path 24. Instead of such an example, the upstream hydraulic pressure sensor 100 may be attached to the hydraulic pressure flow path 86 on the upstream side of the electromagnetic valve 85, or may be attached to the cylinder body 28 to directly detect the master cylinder pressure Pmc in the first master chamber 76.

Similarly, the upstream hydraulic pressure sensor 102 detects the upstream hydraulic pressure supplied from the second master chamber 78 to the second control system 90 of the braking actuator 14. As an example, the upstream hydraulic pressure sensor 102 is attached to the hydraulic pressure flow path 26. Instead of such an example, the upstream hydraulic pressure sensor 102 may be attached to the hydraulic pressure flow path 96 on the upstream side of the electromagnetic valve 95, or may be attached to the cylinder body 28 to directly detect the master cylinder pressure Pmc in the second master chamber 78.

Note that, in the example in which the hydraulic pressure generation device 12 and the braking actuator 14 are configured as separate units, the upstream hydraulic pressure sensors 100, 102 may be incorporated in a unit on a side of the braking actuator 14, or may be incorporated in a unit on a side of the hydraulic pressure generation device 12.

### 2. Failure Determination for Braking Actuator

For detection of a failure of the braking actuator 14, the ECU 18 sequentially executes an “upstream pressure maintaining process”, a “downstream pressurization process”, and a “failure determination process” described below.

In the upstream pressure maintaining process, the hydraulic pressure generation device 12 is controlled to increase and maintain the upstream hydraulic pressure (master cylinder pressure Pmc). In the downstream pressurization process, the braking actuator 14 is controlled such that the hydraulic fluid is supplied to each of the wheel cylinders 16FL, 16FR, 16RL, 16RR through the hydraulic pressure flow paths 24, 26 in a state in which the upstream hydraulic pressure is maintained by the upstream pressure maintaining process. More specifically, by maintaining the upstream hydraulic pressure by the upstream pressure maintaining process while increasing the upstream hydraulic pressure, the hydraulic fluid can be well supplied to the braking actuator 14 from the side of each of the master chambers 76, 78 that are in a sealed state by the control of the braking actuator 14 in the downstream pressurization process that is subsequently executed. Moreover, in the failure determination process, in a case where the upstream hydraulic pressure is not decreased to be equal to or lower than a determination threshold value THpmc as the downstream pressurization process is executed, a determination is made that the failure has occurred in the braking actuator 14.

More specifically, in the failure determination process according to the present embodiment, in a case where the upstream hydraulic pressure is not decreased to be equal to or lower than the determination threshold value THpmc when predetermined time T has elapsed from the start of the downstream pressurization process, a determination is made that the failure has occurred in the braking actuator 14.

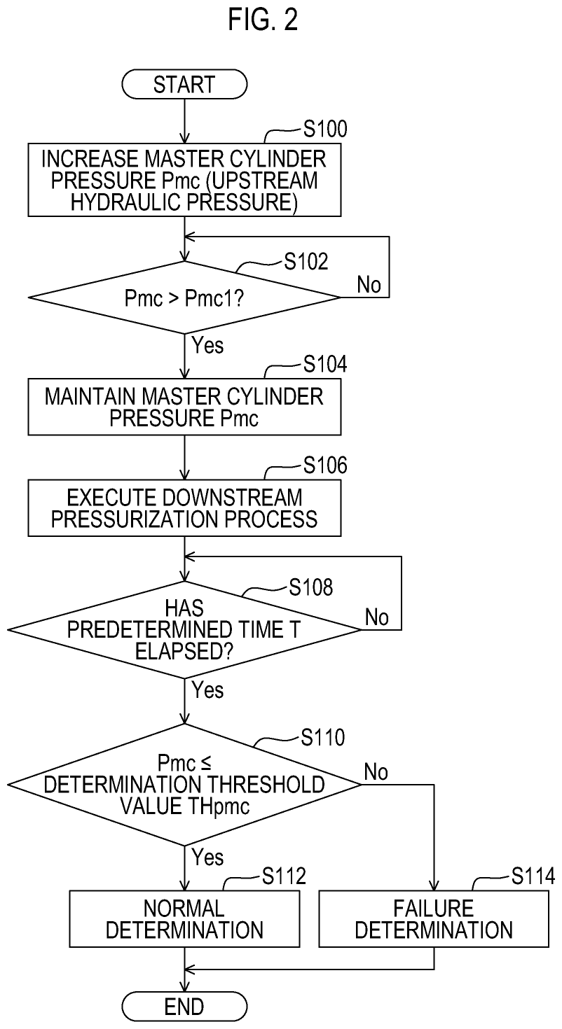

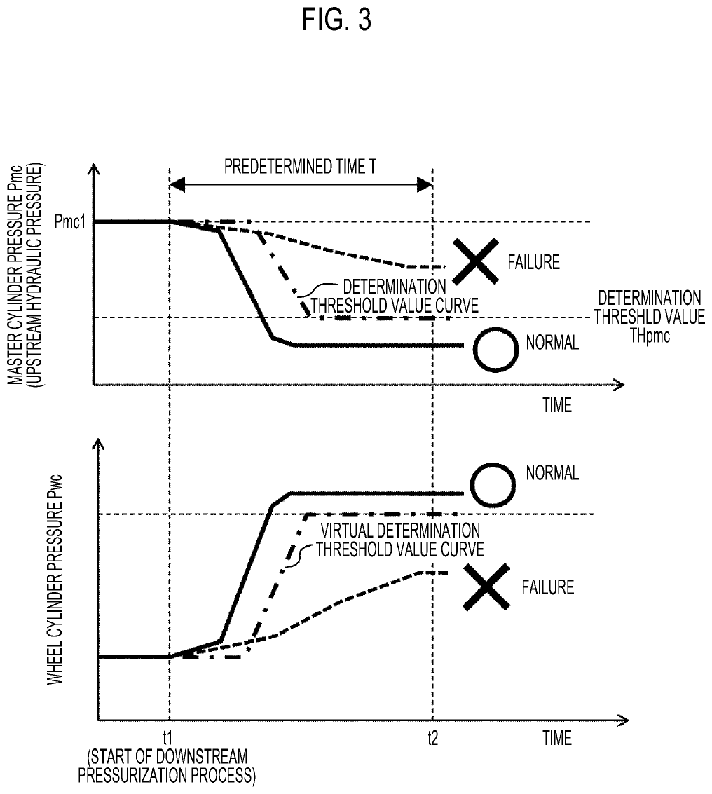

FIG. 2 is a flowchart showing a flow of a process related to the failure determination for the braking actuator 14 according to the embodiment. The process of the flowchart is executed, for example, in a case where a predetermined execution condition related to the failure determination is satisfied while the vehicle is stopped. FIG. 3 is a time chart showing behavior of the master cylinder pressure Pmc and the wheel cylinder pressure Pwc during the execution of the failure determination for the braking actuator 14 according to the embodiment.

The processes of steps S100 to S104 in FIG. 2 correspond to the upstream pressure maintaining process.

First, in step S100, the ECU 18 (processor) controls the hydraulic pressure generation device 12 such that the master cylinder pressure Pmc (upstream hydraulic pressure) is increased to a predetermined value Pmc1. Specifically, the ECU 18 increases the master cylinder pressure Pmc by controlling the opening degrees of the pressure increase valve 58 and the pressure decrease valve 60 provided in the servo pressure generation device 22 to increase the servo pressure Psv. Note that the ECU 18 drives the electric motor 64 to actuate the pump 66 in a case where it is needed to increase the accumulator pressure Pa to increase the master cylinder pressure Pmc to the predetermined value Pmc1.

Next, in step S102, the ECU 18 determines whether or not the master cylinder pressure Pmc is increased to the predetermined value Pmc1. As a result, in a case where a determination result is Yes (Pmc>Pmc1), the process proceeds to step S104.

In step S104, the ECU 18 (fully) closes the pressure decrease valve 60 of the servo pressure generation device 22 such that the master cylinder pressure Pmc is maintained at the predetermined value Pmc1. In a case where the pump 66 is actuated in step S100, the actuation of the pump 66 is stopped. As a result, a state is obtained in which the master cylinder pressure Pmc (upstream hydraulic pressure) is maintained at the predetermined value Pmc1.

Next, in step S106, the ECU 18 executes the downstream pressurization process. Specifically, in the downstream pressurization process, the ECU 18 controls the braking actuator 14 as follows in the state in which the master cylinder pressure Pmc is maintained at the predetermined value Pmc1 as at point in time t1 in FIG. 3. That is, the ECU 18 drives the electric motor 79 to actuate the pumps 84, 94 while controlling the opening degrees of the electromagnetic valves 85, 95 to be smaller than in the fully open state. As a result, a differential pressure can be formed such that each wheel cylinder pressure Pwc is higher than the master cylinder pressure Pmc.

Next, the processes of steps S108 to S114 in FIG. 2 correspond to the failure determination process.

In a case where the downstream pressurization process is executed as described above, the hydraulic fluid is pressure-fed by the pumps 84, 94 and supplied to each of the wheel cylinders 16FL, 16FR, 16RL, 16RR from the side of the master cylinder through the hydraulic pressure flow paths 24, 26. As a result, in a case where the braking actuator 14 is normal, the hydraulic fluid inside the braking actuator 14 is pressurized. That is, as indicated by a solid line in a lower part of FIG. 3, each wheel cylinder pressure Pwc is increased after the elapse of point in time t1.

Moreover, the hydraulic fluid needed to pressurize the braking actuator 14 is drawn into the braking actuator 14 from the master cylinder 20 (hydraulic pressure generation device 12) that maintains the pressurized hydraulic fluid. Therefore, in a case where the hydraulic fluid is normally pressurized by the braking actuator 14, the master cylinder pressure Pmc is decreased as indicated by a solid line in an upper part of FIG. 3. Therefore, the behavior (increase) of the wheel cylinder pressure Pwc can be grasped in a simulated manner by using the behavior (decrease) of the master cylinder pressure Pmc.

On the other hand, in a case where some kind of failure (for example, a failure of a component of the braking actuator 14, such as the pumps 84, 94 or the electromagnetic valves 85, 95) has occurred in the braking actuator 14, for example, as indicated by a dashed line in the lower part of FIG. 3, the wheel cylinder pressure Pwc is solely increased to a value lower than in the normal. Alternatively, depending on an aspect of the failure, the wheel cylinder pressure Pwc may not be substantially increased. Moreover, along with the above, as shown by a dashed line in the upper part of FIG. 3, the master cylinder pressure Pmc on the upstream side is solely decreased to a value higher than in the normal. Alternatively, depending on the aspect of the failure, the master cylinder pressure Pmc may not be substantially decreased.

As described above, the influence of the failure of the braking actuator 14 on the pressurization of the braking actuator 14 by the downstream pressurization process executed along with the upstream pressure maintaining process is exerted on the master cylinder pressure Pmc on the upstream side in addition to the wheel cylinder pressure Pwc inside the braking actuator 14. Therefore, the upstream hydraulic pressure sensors 100, 102 are used in the failure determination process according to the present embodiment to enable the detection of the failure of the braking actuator 14 without the detection of each wheel cylinder pressure Pwc.

Here, as indicated by the solid line in the lower part of FIG. 3, the wheel cylinder pressure Pwc is increased with a delay after the start of the downstream pressurization process, and eventually is fixed. Correspondingly, as indicated by the solid line in the upper part of FIG. 3, the master cylinder pressure Pmc is decreased with a delay after the start of the downstream pressurization process, and eventually is fixed. In addition, a virtual determination threshold value curve (chain line) is shown in the lower part of FIG. 3. The virtual determination threshold value curve indicates a change in the wheel cylinder pressure Pwc that occurs at the latest and at least, in consideration of various variation factors in a case where the failure has not occurred in the braking actuator 14. The upper part of FIG. 3 shows the determination threshold value curve (chain line) specified corresponding to the virtual determination threshold value curve.

From the above, basically, in a case where the master cylinder pressure Pmc is lower than the determination threshold value curve, a determination can be made that the braking actuator 14 is normal, and in a case where the master cylinder pressure Pmc is not lower than the determination threshold value curve, a determination can be made that the failure has occurred in the braking actuator 14. However, as shown in the upper part of FIG. 3, since a decrease amount of the master cylinder pressure Pmc is small immediately after the start of the downstream pressurization process, in a case where the failure determination is made based on the value of the master cylinder pressure Pmc immediately after the start, there is a probability that an erroneous determination is made.

In view of the above points, it is desirable to make the failure determination of the braking actuator 14 at a timing at which a determination can be made that the master cylinder pressure Pmc has finished decreasing sufficiently after the start of the downstream pressurization process in a case where the braking actuator 14 is normal. Therefore, in step S108, the ECU 18 determines whether or not predetermined time T has elapsed from the start of the downstream pressurization process in step S106 (point in time t1 in FIG. 3). Predetermined time T is experimentally acquired in advance and stored in the storage device of the ECU 18 such that the timing (for example, point in time t2 in FIG. 3) can be specified.

After predetermined time T has elapsed in step S108, the process proceeds to step S110. In step S110, the ECU 18 determines whether or not the master cylinder pressure Pmc is decreased to be equal to or lower than the determination threshold value THpmc. The determination threshold value THpmc is a value on the determination threshold value curve at a point in time when predetermined time T has elapsed (point in time t2 in FIG. 3), and is acquired in advance and stored in the storage device of the ECU 18.

In the example of the vehicle braking device 10 having the configuration shown in FIG. 1, the determination in step S110 is made for each of the first and second control systems 80, 90 of the braking actuator 14. That is, in step S110, the ECU 18 determines whether or not the master cylinder pressure Pmc detected by each of the upstream hydraulic pressure sensors 100, 102 is equal to or lower than the determination threshold value THpmc.

Note that, in the example of the vehicle braking device including the hydraulic pressure flow path that can be communicated between the hydraulic pressure flow paths 24, 26 that supply the upstream hydraulic pressure to each of the first and second control systems 80, 90, and the hydraulic pressure sensor attached to the hydraulic pressure flow path, the failure determination for both the first and second control systems 80, 90 may be made by using the hydraulic pressure sensor (that is, one upstream hydraulic pressure sensor).

In a case where the determination results of both the first and second control systems 80, 90 are Yes (Pmc THpmc) in step S110, the process proceeds to step S112, and the ECU 18 determines that the braking actuator 14 is normal.

On the other hand, in a case where the determination result of one or both of the first and second control systems 80, 90 is No (Pmc>THpmc) in step S110, the process proceeds to step S114, and the ECU 18 determines that the failure has occurred in the braking actuator 14.

### 3. Effect

As described above, with the vehicle braking device 10 according to the present embodiment, the upstream pressure maintaining process, the downstream pressurization process, and the failure determination process are sequentially executed by cooperatively driving the hydraulic pressure generation device 12 on the upstream side and the braking actuator 14 on the downstream side. As a result, the failure determination of the braking actuator 14 can be made by using each of the upstream hydraulic pressure sensors 100, 102 that detect the master cylinder pressure Pmc (upstream hydraulic pressure) supplied to the braking actuator 14 (that is, indirectly). With such a method, the failure determination of the braking actuator 14 can be made without including a plurality of hydraulic pressure sensors that directly detects the individual wheel cylinder pressures Pwc (that is, while suppressing an increase in cost).

More specifically, with the failure determination process according to the present embodiment, in a case where the master cylinder pressure Pmc (upstream hydraulic pressure) is not decreased to be equal to or lower than the determination threshold value THpmc when predetermined time T has elapsed from the start of the downstream pressurization process, a determination is made that the failure has occurred in the braking actuator 14. As a result, the failure determination can be made more accurately in consideration of the behavior (see FIG. 3) of the wheel cylinder pressure Pwc and the master cylinder pressure Pmc as the upstream pressure maintaining process and the downstream pressurization process are executed.

### 4. Another Configuration Example of the Hydraulic Pressure Generation Device

In the hydraulic pressure generation device 12 having the configuration shown in FIG. 1 described above, each of the first and second control systems 80, 90 of the braking actuator 14 receives the supply of the “upstream hydraulic pressure” through the master cylinder 20 (first and second master chambers 76, 78). Instead of such an example, in the “braking actuator” according to the present disclosure, one of the first and second control systems may be configured to receive the supply of the upstream hydraulic pressure without going through the master cylinder. Specifically, for example, one of the first and second control systems may be configured to directly receive the supply of the hydraulic fluid pressurized by the power hydraulic pressure source (for example, the power hydraulic pressure source 56 shown in FIG. 1) provided in the hydraulic pressure generation device without going through the master cylinder. In such a configuration, the hydraulic pressure supplied from the power hydraulic pressure source to one of the first and second control systems corresponds to another example of the “upstream hydraulic pressure” according to the present disclosure.

What is claimed is:

1. A vehicle braking device comprising:
a braking actuator configured to control a hydraulic pressure in a wheel cylinder;
a hydraulic pressure generation device connected to the braking actuator through a hydraulic pressure flow path and configured to execute increasing and maintaining an upstream hydraulic pressure supplied to the braking actuator through the hydraulic pressure flow path;
a hydraulic pressure sensor configured to detect the upstream hydraulic pressure; and
an electronic control unit,
wherein the electronic control unit is configured to execute
an upstream pressure maintaining process of controlling the hydraulic pressure generation device to increase and maintain the upstream hydraulic pressure,
a downstream pressurization process of controlling the braking actuator such that hydraulic fluid is supplied to the wheel cylinder through the hydraulic pressure flow path in a state in which the upstream hydraulic pressure is maintained, and
a failure determination process of determining that a failure has occurred in the braking actuator in a case where the upstream hydraulic pressure is not decreased to be equal to or lower than a determination threshold value as the downstream pressurization process is executed.

2. The vehicle braking device according to claim 1, wherein, in the failure determination process, the electronic control unit is configured to determine that the failure has occurred in the braking actuator in a case where the upstream hydraulic pressure is not decreased to be equal to or lower than the determination threshold value when a predetermined time has elapsed from start of the downstream pressurization process.

3. A failure determination method for a vehicle braking device including a braking actuator configured to control a hydraulic pressure in a wheel cylinder, a hydraulic pressure generation device connected to the braking actuator through a hydraulic pressure flow path and configured to execute increasing and maintaining an upstream hydraulic pressure supplied to the braking actuator through the hydraulic pressure flow path, and a hydraulic pressure sensor configured to detect the upstream hydraulic pressure, the failure determination method comprising:
an upstream pressure maintaining process of controlling the hydraulic pressure generation device to increase and maintain the upstream hydraulic pressure;
a downstream pressurization process of controlling the braking actuator such that hydraulic fluid is supplied to the wheel cylinder through the hydraulic pressure flow path in a state in which the upstream hydraulic pressure is maintained; and
a failure determination process of determining that a failure has occurred in the braking actuator in a case where the upstream hydraulic pressure is not decreased to be equal to or lower than a determination threshold value as the downstream pressurization process is executed.

4. The failure determination method according to claim 3, wherein, in the failure determination process, a determination is made that the failure has occurred in the braking actuator in a case where the upstream hydraulic pressure is not decreased to be equal to or lower than the determination threshold value when a predetermined time has elapsed from start of the downstream pressurization process.
